(19) United States
(12) Patent Application Publication
(10) Pub. No.: US 2014/0285932 A1
(43) Pub. Date: Sep. 25, 2014

(54) ELECTROSTATIC PROTECTION CIRCUIT

(71) Applicant: KABUSHIKI KAISHA TOSHIBA, Tokyo (JP)

(72) Inventors: Shinya MIYAMOTO, Kanagawa (JP); Chikashi NAKAGAWARA, Kanagawa (JP)

(73) Assignee: KABUSHIKI KAISHA TOSHIBA, Tokyo (JP)

(21) Appl. No.: 14/017,232

(22) Filed: Sep. 3, 2013

(30) Foreign Application Priority Data
Mar. 25, 2013 (JP) 2013-062280

(51) Int. Cl. H02H 3/20

(52) U.S. Cl. CPC H02H 3/20
USPC 361/56

(57) ABSTRACT

A protection circuit comprises first and second input terminals to which a power source voltage for a protected load circuit can be applied. A first transistor connected between the input terminals. The first transistor has a gate/base electrode connected to a current path electrode through a resistor. A low-pass filter is connected in parallel with the first transistor between the input terminals. A second transistor connected in parallel with the resistor, and having a control electrode connected to an output terminal of the low-pass filter. Zener diodes may be optionally included to provide overvoltage protection. In some embodiments, the low-pass filter may comprise a series-connected resistor and capacitor.

### CROSS-REFERENCE TO RELATED APPLICATION

This application is based upon and claims the benefit of priority from Japanese Patent Application No. 2013-062280, filed Mar. 25, 2013, the entire contents of which are incorporated herein by reference.

### FIELD

Embodiments described herein relate generally to an electrostatic protection circuit.

### BACKGROUND

The development of a semiconductor device mounted on a vehicle-mounted electronic control unit as a single chip has been in progress. For example, a circuit in which a digital IC, an analog IC, a microprocessor, a memory, a power source IC, a power source device and the like are combined has been integrated in a single LSI chip. An input interface circuit of a semiconductor integrated circuit is required to possess resistance against severe surges. A surge is known as a steep change in a voltage or a current and an example of surge is an electrostatic discharge (hereinafter referred to as ESD) from a human body or a assembly machine.

A protection circuit is connected to an integrated circuit such as an LSI chip to provide surge resistance. The protection circuit protects an LSI chip by absorbing the surge. With respect to conventional protection circuits, there has been known an ESD protection circuit which makes use of the breakdown of a MOS transistor caused by diode connection due to short-circuiting of a gate electrode and a source electrode. In this ESD protection circuit, however, a breakdown current is small and hence, it is necessary to make the MOS transistor large-sized, and since the MOS transistor is provided as part of the IC, the whole chip becomes large in size.

There has been also known a protection circuit where a gate electrode of a MOS transistor is connected to a source potential through a resistor, and the MOS transistor is made to perform a transistor operation against the ESD, thus allowing smaller chip size.

However, in the protection circuit which uses transistor operation, the transistor is also operated as the protection circuit against a steep rise of a voltage at the start time (startup) of supplying power source and hence, a so-called “rush current” or “on-rush” current flows into the MOS transistor potentially causing an erroneous operation of the protected internal circuit or breakdown of the transistor.

### BRIEF DESCRIPTION OF THE DRAWINGS

FIG. 1 is a circuit diagram of an electrostatic protection circuit according to a first embodiment.

FIG. 2A and FIG. 2B are circuit diagrams depicting an operation of the electrostatic protection circuit according to the first embodiment.

FIG. 3A is a graph depicting a terminal voltage level over time when an ESD is applied to the electrostatic protection circuit according to the first embodiment.

FIG. 3B is a graph depicting a surge current level over time when an ESD is applied to the electrostatic protection circuit according to the first embodiment.

FIG. 4A is a graph depicting a steep rise in terminal voltage level when a power source voltage is supplied to input terminals of the electrostatic protection circuit according to the first embodiment.

FIG. 4B is a graph depicting a rush current flowing into the electrostatic protection circuit at the time of supplying the power source voltage.

FIG. 5 is a circuit diagram of an electrostatic protection circuit according to a second embodiment.

FIG. 6 is a circuit diagram of an electrostatic protection circuit according to a third embodiment.

FIG. 7 is a circuit diagram of an electrostatic protection circuit according to a fourth embodiment.

### DETAILED DESCRIPTION

In general, according to one embodiment, an protection circuit includes first and second input terminals to which a power source voltage for a protected circuit can be applied, a first transistor having a first electrode and a second electrode connected between the first and second input terminals, and a third (control) electrode connected to the second electrode through a first resistor. The protection circuit also includes a low-pass filter is connected in parallel with the first transistor between the first and second input terminals. A second transistor is connected in parallel with the first resistor. A third (control) electrode of the second transistor is connected to an output terminal of the low-pass filter.

As used herein, “transistor” includes a MOS transistor and a bipolar transistor. A “first electrode” includes a drain electrode of the MOS transistor or a collector electrode of the bipolar transistor. A “second electrode” includes a source electrode of the MOS transistor or an emitter electrode of the bipolar transistor. A “third electrode” includes a gate electrode of the MOS transistor or a base electrode of the bipolar transistor, and may also be referred to as a “control electrode.”

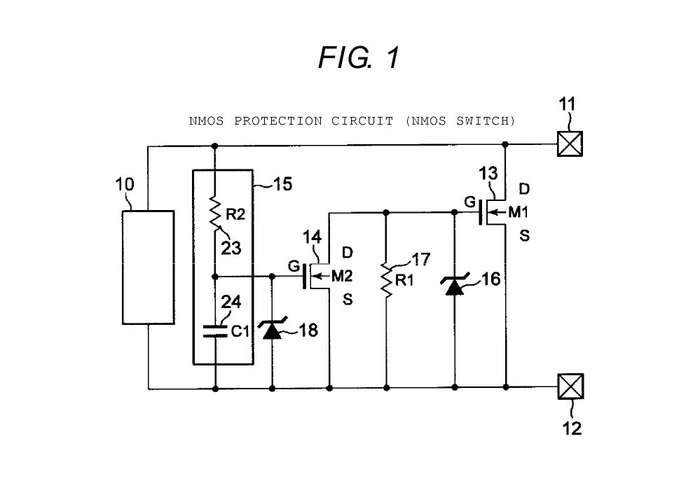

Hereinafter, electrostatic protection circuits of embodiments are explained in conjunction with FIG. 1 to FIG. 7. In respective drawings, identical parts are indicated by same symbols and the repeated explanation of these parts may be omitted.

### First Embodiment

FIG. 1 is a circuit diagram of an electrostatic protection circuit according to the first embodiment. The electrostatic protection circuit according to this embodiment is a protection circuit which uses a MOS transistor switch. The electrostatic protection circuit includes: an internal circuit 10 which is an object to be protected; input terminals 11, 12 which supply a power source voltage to the internal circuit 10; first and second MOS transistors 13, 14 and a low-pass filter 15.

For the first MOS transistor 13, a drain electrode and a source electrode are connected between the input terminals 11, 12 respectively, and a gate electrode is connected to the source electrode via a resistor 17. For the second MOS transistor 14, an output signal from the low-pass filter 15 is inputted to a gate electrode, and a drain electrode is connected to the gate electrode of the first MOS transistor 13, and a source electrode is connected to the source electrode of the first MOS transistor 13. The low-pass filter 15 is connected in parallel with the first MOS transistor 13 between the input terminals 11, 12.

The internal circuit 10 is, for example, an LSI chip into which various functional circuits are incorporated, and is a circuit which is operated by a power source connected to the input terminals 11, 12.

The first input terminal 11 and the second input terminal 12 are connected to, for example, a positive power source potential from a vehicle-mounted battery and a ground potential respectively. A pulse-like ESD surge is applied to the input terminals 11, 12 when these input terminals 11, 12 are brought into contact with, for example, a charged human body or a charged assembly machine.

The first MOS transistor 13 protects the internal circuit 10 by preventing an ESD surge from being applied to the internal circuit 10 by a transistor operation. Here, in this example, the first MOS transistor 13 is an NMOS transistor so a parasitic capacitance is generated between the drain electrode and the gate electrode of the first MOS transistor 13.

A Zener diode 16 and a resistor 17 for overvoltage protection are connected in parallel between the gate electrode of the first MOS transistor 13 and a ground potential. The resistor 17 is a resistance element for imparting a voltage bias to the gate electrode of the first MOS transistor 13. The resistor 17 has a resistance value R1.

The low-pass filter 15 is a low-pass filter where a resistor 23 and a capacitor 24 are connected in series. The low-pass filter 15 outputs a terminal voltage between the input terminals 11, 12 based on a filter time constant determined by a product of a resistance value R2 and capacitor C1.

The second MOS transistor 14 can also be an NMOS transistor. The gate electrode of the second MOS transistor 14 is connected to a connection point (node) between the resistor and the capacitor of the low-pass filter 15. A Zener diode 18 for overvoltage protection is connected between the gate electrode of the second MOS transistor 14 and the ground potential.

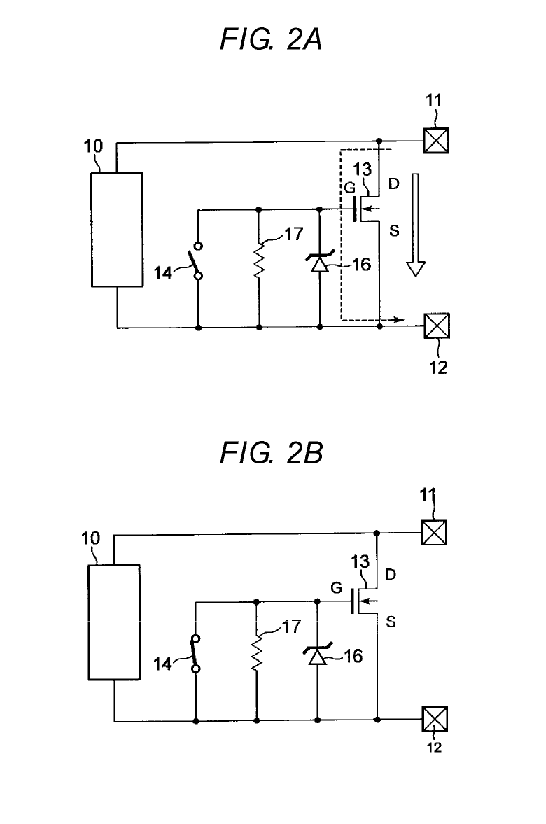

Next, the manner of operation of the electrostatic protection circuit shown in FIG. 1 is explained in conjunction with FIG. 2 to FIG. 4.

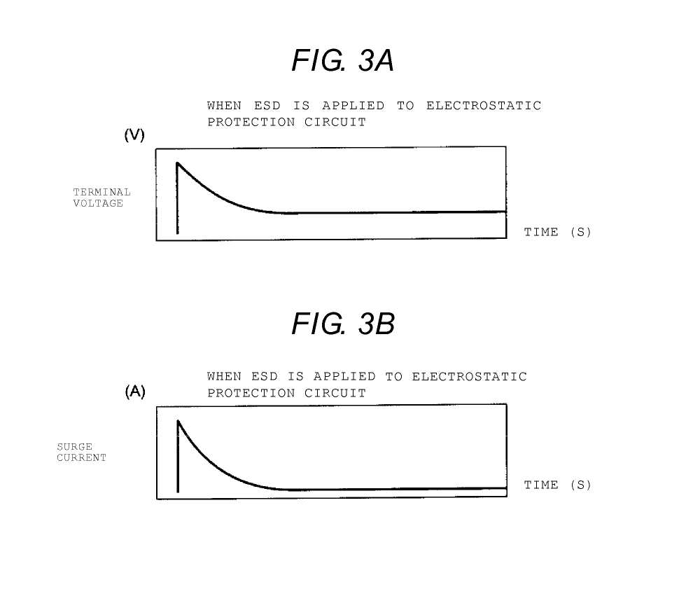

In a state where a power source voltage is not applied to the electrostatic protection circuit, the second MOS transistor 14 is in an OFF state as shown in FIG. 2A. When an ESD voltage having a waveform shown in FIG. 3A is applied to the input terminals 11, 12, an electric current flows into a CR time constant circuit including the gate parasitic capacitance of the first MOS transistor 13 and the resistance 17 and a gate voltage rises. As a result, the first MOS transistor 13 is brought into an ON state, and a surge current flows into the first MOS transistor 13 as shown in FIG. 2A. Accordingly, a rush current does not flow into the internal circuit and hence, the internal circuit is effectively protected from an ESD voltage.

Although an ESD voltage is also applied to the low-pass filter 15, the ESD voltage is constituted of a high-frequency component and hence, the low-pass filter 15 does not output the ESD voltage. Accordingly, the second MOS transistor 14 is held in an OFF state.

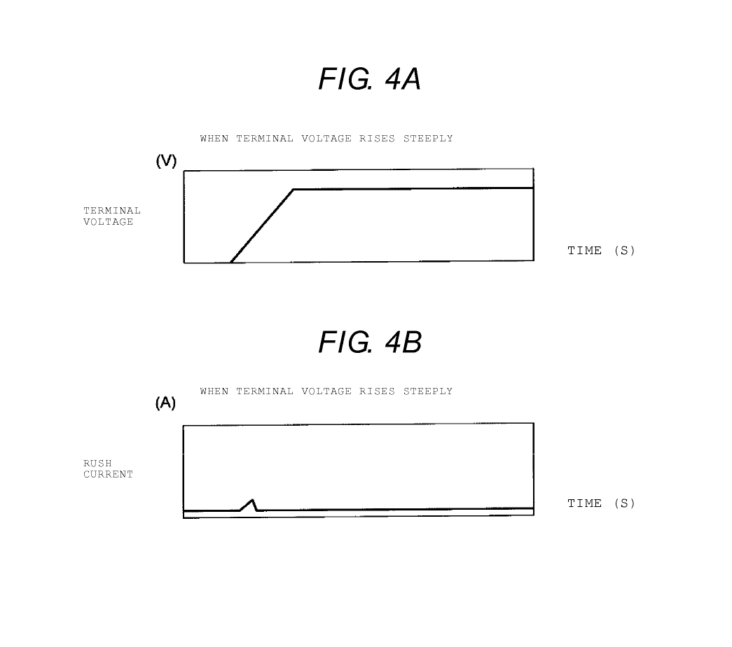

Next, the explanation is made with respect to the case where a power source voltage is applied between the input terminals 11, 12. In a normal state, a voltage having a waveform slower than a rising speed of an ESD is applied between the input terminals 11, 12. In this case, a power source voltage rises with a steep inclination angle from a ground voltage (see FIG. 4A). Although a change rate at the time of rising of the power source voltage is steep, the change is small compared to a change in ESD voltage, and the power source voltage is constituted of a frequency component lower than that of the ESD voltage. The power source voltage is supplied to the gate electrode of the second MOS transistor 14 through the low-pass filter 15. As a result, the second MOS transistor 14 is brought into an ON state. When the second MOS transistor 14 is in an ON state, the gate electrode of the first MOS transistor 13 assumes a ground potential and hence, the first MOS transistor 13 is brought into an OFF state.

When a power source voltage rises, the first MOS transistor 13 momentarily responds to a change in power source voltage at the time of rising in the same manner as an ESD voltage and is brought into an ON state. However, when the second MOS transistor 14 is brought into an ON state, the first MOS transistor 13 is forcibly brought into an OFF state. Accordingly, as shown in FIG. 4, a trivial amount of rush current flows between the drain electrode and the source electrode of the first MOS transistor 13 and hence, the first MOS transistor 13 does not function as a protection circuit for the internal circuit 10.

In this manner, according to the electrostatic protection circuit of this embodiment, an ESD pulse and rising of a power source voltage which differs from the ESD pulse can be clearly distinguished from each other. Accordingly, it is possible to protect the internal circuit 10 without causing an erroneous operation even when a power source voltage rises steeply.

ESD breakdown mainly occurs in manufacturing steps of an LSI. When no parts are connected to the electrostatic protection circuit, the electrostatic protection circuit is operated as shown in FIG. 2A so that the ESD resistance is ensured. On the other hand, when ESD is applied to the electrostatic protection circuit after the LSI is assembled to a unit, a charge of the ESD is dispersed. The ESD resistance after assembling is increased compared to the LSI in the form of a single body. Accordingly, by changing the circuit shown in FIG. 2A to the circuit shown in FIG. 2B when a voltage is applied, it is possible to prevent an erroneous operation while ensuring ESD resistance.

### Second Embodiment

Although the MOS transistor in the first embodiment is constituted of the NMOS (n-channel) transistor, the MOS transistor may be constituted of a PMOS (p-channel) transistor.

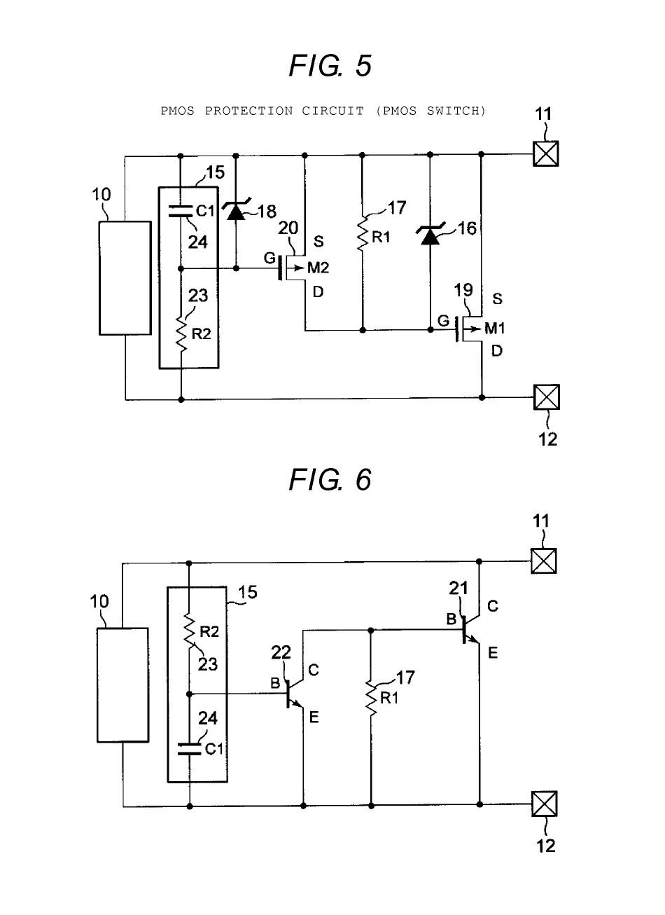

FIG. 5 is a circuit diagram of an electrostatic protection circuit according to the second embodiment. In this electrostatic protection circuit, a first MOS transistor 19 and a second MOS transistor 20 are formed of a PMOS transistor. A power source voltage by which an input terminal 11 takes a positive side is supplied to the electrostatic protection circuit, and an input terminal 12 takes a negative side. A drain electrode and a source electrode of the first MOS transistor 19 are connected between the input terminals 11, 12. A drain electrode, a source electrode and a resistor 17 of the second MOS transistor 20 are connected in parallel between the input terminal 11 and a gate electrode of the first MOS transistor 19. The resistor 17 imparts a voltage bias to the gate electrode of the first MOS transistor 19.

A low-pass filter 15 includes a resistor 23 and a capacitor 24 connected in series between the input terminals 11, 12. A connection point (node) between a resistor 23 and a capacitor 24 of the low-pass filter 15 is connected to a gate electrode of the second MOS transistor 20. The connection point (node) between the resistor 23 and the capacitor 24 constitutes an output terminal of the low-pass filter 15.

A Zener diode 16 for overvoltage protection is connected between the gate electrode of the first MOS transistor 19 and the input terminal 11. A Zener diode 18 for overvoltage protection is connected between the gate electrode of the second MOS transistor 20 and the input terminal 11.

The manner of operation of the electrostatic protection circuit according to the second embodiment is equivalent to the manner of operation of the electrostatic protection circuit according to the first embodiment and hence, the explanation of the manner of operation of the electrostatic protection circuit according to the second embodiment is omitted.

### (Modification)

The first MOS transistor 13, 19 may have the double diffused metal oxide semiconductor field effect transistor (DMOSFET) structure. In this case, the first MOS transistor 13 is manufactured such that a P-type well is formed on an N-type silicon substrate, an N-type source electrode region and an N-type drain region are formed in the P-type well, and a gate electrode is formed on the P-type well by way of an insulation film, for example. The electrostatic protection circuit which uses the DMOS transistor as the first MOS transistor 13, 19 is operated substantially in the same manner as the electrostatic protection circuit of the above-mentioned example.

### Third Embodiment

An electrostatic protection circuit according to the third embodiment uses bipolar transistors.

FIG. 6 is a circuit diagram of an electrostatic protection circuit according to the third embodiment. The first and second bipolar transistors 21, 22 are formed of an NPN bipolar transistor. A power source voltage, of which an input terminal 11 takes a positive side, is supplied to the electrostatic protection circuit, and an input terminal 12 takes a negative side. An emitter electrode and a collector electrode of the first bipolar transistor 21 are connected between the input terminals 11, 12. A base electrode of the first bipolar transistor 21 is connected to an emitter potential via a resistor 17 and hence, the first bipolar transistor 21 performs a transistor operation against an ESD.

An emitter electrode and a collector electrode of the second bipolar transistor 22 are connected between the input terminal 12 and the base electrode of the first bipolar transistor 21. A low-pass filter 15 which is a resistor 23 and a capacitor 24 is connected in series between the input terminals 11, 12. A connection point (node) between the resistor 23 and a capacitor 24 of the low-pass filter 15 is connected to abase electrode of the second bipolar transistor 22. The connection point (node) between the resistor 23 and the capacitor 24 is an output terminal of the low-pass filter 15.

The manner of operation of the electrostatic protection circuit according to the third embodiment having the above-mentioned configuration is equivalent to the manner of operation of the electrostatic protection circuit according to the first embodiment and hence, the explanation of the manner of operation of the electrostatic protection circuit according to the third embodiment is omitted. Here, a PNP transistor maybe used as the bipolar transistor instead of using the NPN transistor. Further, the resistor 17 is not always required in the electrostatic protection circuit using the bipolar transistor 21.

### Fourth Embodiment

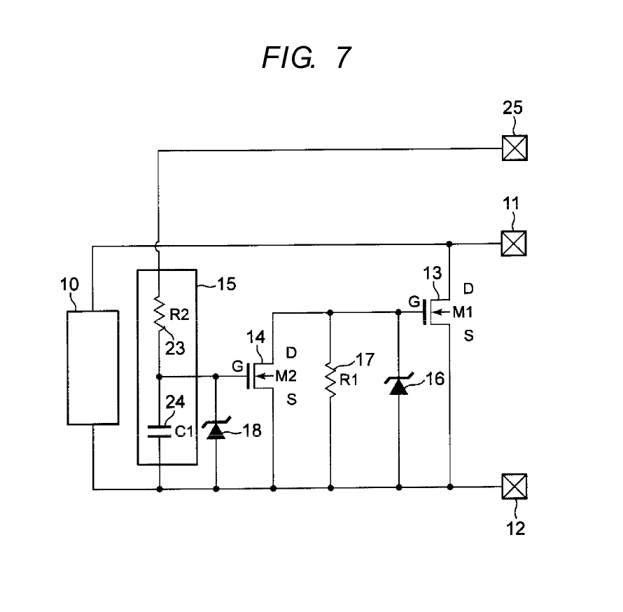

A modification of the first embodiment is explained as the fourth embodiment. FIG. 7 is a circuit diagram of an electrostatic protection circuit according to the fourth embodiment.

A low-pass filter 15 of the electrostatic protection circuit according to this embodiment is connected between a second input terminal 12 and a third input terminal (power source terminal) 25. A power source not shown in the drawing is supplied to the third input terminal.

When a voltage is applied to the third input terminal 25, a second MOS transistor 14 is always in a Vdss mode (corresponding to an OFF state shown in FIG. 2A). Accordingly, even when a voltage between input terminals 11, 12 changes extremely steeply, the first MOS transistor 13 does not perform the transistor operation and hence, an erroneous operation does not occur. Further, when an ESD is applied to the electrostatic protection circuit, a surge current flows into the first MOS transistor 13 in a Vdsr mode and hence, an internal circuit 10 is protected.

Alternatively, a voltage source may be connected to the third input terminal 25 shown in FIG. 7. By connecting the voltage source having a gentle change in voltage waveform to the input terminal 25, an erroneous operation can be prevented in the same manner.

According to the electrostatic protection circuit of this embodiment, the protection substantially equal to the protection acquired by the first embodiment can be acquired.

The ESD breakdown mainly occurs in manufacturing steps of the LSI. When no parts are connected to the electrostatic protection circuit, the ESD resistance is ensured by performing the Vdsr operation. On the other hand, when ESD is applied to the electrostatic protection circuit after the LSI is assembled to a unit, a charge of the ESD is dispersed. The ESD resistance after assembling is increased compared to the LSI in the form of a single body. Accordingly, when the power source is supplied, the Vdss operation is performed mainly for preventing an erroneous operation.

Although various embodiments have been explained heretofore, the present disclosure is not limited to these specific example embodiments, and the present disclosure can be embodied in various modifications, rearrangements, and variations on these example embodiments without departing from the gist of the present disclosure.

The low-pass filter 15 is, in a most simplified form, the resistor 23 and the capacitor 24 connected in series. However, the low-pass filter 15 may be an active-type low-pass filter formed of an operational amplifier or a transistor circuit. The combination of receiving elements of the low-pass filter 15 or the manner of connecting the receiving elements or the like in series or in parallel to each other can be variably modified.

Although Zener diodes 16, 18 which are connected to the gate electrodes of the first transistor and the second transistor are provided for protecting gate electrodes, these Zener diodes 16, 18 are not always required and may be omitted.

While certain embodiments have been described, these embodiments have been presented by way of example only, and are not intended to limit the scope of the inventions. Indeed, the embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A protection circuit, comprising:
first and second input terminals to which a power source voltage for a protected circuit can be applied;
a first transistor having a first electrode and a second electrode connected between the first and second input terminals, a third electrode of the first transistor connected to the second electrode of the first transistor through a first resistor;
a low-pass filter connected in parallel with the first transistor between the first and second input terminals; and
a second transistor connected in parallel with the first resistor, a third electrode of the second transistor connected to an output terminal of the low-pass filter.

2. The protection circuit of claim 1, further comprising:
a first Zener diode connected in parallel with the first resistor.

3. The protection circuit of claim 1, wherein the low-pass filter comprises a second resistor and a first capacitor connected in series between the first input terminal and the second input terminal and the output terminal of the low-pass filter is a node between the second resistor and the first capacitor.

4. The protection circuit of claim 3, wherein the second resistor is between the first input terminal and the second capacitor.

5. The protection circuit of claim 3, wherein the second resistor is between the second input terminal and the second capacitor.

6. The protection circuit of claim 1, further comprising:
a first Zener diode connected between the second electrode of the first transistor and the third electrode of the third electrode; and
a second Zener diode connected between the second electrode of the second transistor and the third electrode of the second transistor.

7. The protection circuit of claim 1, wherein the first transistor and the second transistor are n-channel metal-oxide-semiconductor transistors.

8. The protection circuit of claim 1, wherein the first transistor and second transistor are p-channel metal-oxide-semiconductor transistors.

9. The protection circuit of claim 1, wherein the first transistor and the second transistor are bipolar transistors.

10. The protection circuit of claim 1, wherein the low-pass filter is an active-type filter.

11. The protection circuit of claim 10, wherein the low-pass filter includes an operational amplifier.

12. A protection circuit, comprising:
first and second input terminals to which a power source voltage for a protected circuit can be applied;
a first transistor having a first electrode and a second electrode connected between the first and second input terminals, a third electrode of the first transistor connected to the second electrode of the first transistor through a first resistor;
a low-pass filter connected in parallel with the first transistor between the first and second input terminals; and
a second transistor connected in parallel with the first resistor, a third electrode of the second transistor connected to an output terminal of the low-pass filter, wherein
the low-pass filter is configured to filter a variation in the power source voltage resulting from an electrostatic discharge and not to filter a variation in the power source voltage resulting from a voltage rise at startup, and to output a signal corresponding to the filtered power source voltage.

13. The protection circuit of claim 12, further comprising:
a first Zener diode connected between the second electrode of the first transistor and the third transistor of the first transistor; and
a second Zener diode connected between the second electrode of the second transistor and the third electrode of the second transistor.

14. The protection circuit of claim 12, wherein the low-pass filter includes a second resistor and a first capacitor connected in series.

15. The protection circuit according to claim 12, wherein the second transistor is a bipolar transistor.

16. A protection circuit, comprising:
a first input terminal to which a power source potential for a protected circuit can be applied;
a second input terminal to which a ground potential can be applied;
a first transistor having a first electrode connected to the first input terminal, a second electrode connected to the second input terminal, and a third electrode connected to the second electrode through a first resistor;
a switch element connected in parallel with the first resistor; and
a low-pass filter outputting a signal corresponding to a power source voltage from which high-frequency variations have been filtered, wherein
the switch element is configured to open and close according to the signal from the low-pass filter.

17. The protection circuit of claim 16, wherein the low-pass filter is connected in a parallel with the first transistor between the first input terminal and the second input terminal.

18. The protection circuit of claim 16, further comprising:
a third input terminal at which a second power source voltage is supplied, wherein the low-pass filter is connected between the third input terminal and the second input terminal, and the second potential is a ground potential.

19. The protection circuit of claim 16, wherein the signal from the low-pass filter causes the switch element to close when the power source voltage rising steeply during a start-up.

20. The protection circuit of claim 16, wherein the low-pass filter includes a second resistor and a first capacitor connected in series, and the switching element is a transistor.
